(19) United States
(12) Patent Application Publication
(10) Pub. No.: US 2012/0191515 A1
(43) Pub. Date: Jul. 26, 2012

(54) Method For Connecting Consumers For Providing Shopping Advice

(76) Inventor: Charles Katz, San Francisco, CA (US)

(21) Appl. No.: 13/354,753

(22) Filed: Jan. 20, 2012

Related U.S. Application Data
(60) Provisional application No. 61/435,219, filed on Jan. 21, 2011.

(51) Int. Cl. G06Q 30/00; G06Q 30/02

(52) U.S. Cl. 705/14.16; 705/26.7; 705/14.73

(57) ABSTRACT

Disclosed is a method that facilitates an interaction platform for exchanges of user-to-user advice which has the steps of providing a network; providing a host computer system where the host computer is connected to the network and the host computer provides an interaction platform for one or more advice provider to provide advice regarding one or more products to one or more advice receivers and the advice is provided to the advice receiver via the interaction platform where the host computer further provides a database storing one or more attributes of the advice provider and one or more attributes of the advice receiver.

### INCORPORATION BY REFERENCE

This application claims the benefit of priority under 35 U.S.C. 119(e) to the filing date of U.S. provisional patent application No. 61/435,219 “Method for connecting consumers to other consumers for live shopping advice” which was filed on Jan. 23, 2011, and which is incorporated herein by reference in its entirety.

### FIELD OF THE INVENTION

This invention relates to electronic commerce. Specifically, this invention relates to providing a platform for experts to provide shopping advice to shoppers and to receive referral fees as a result. Further, methods for automatically generating a new link from an original link having merchant ID and/or product ID to further include at least an expert ID, a shopper ID, and/or an affiliate ID are disclosed. Such methods may be used in a system for referrals in marketing and recommending goods via the Internet or other interactive network.

### BACKGROUND OF THE INVENTION

With the increasing popularity of the Internet and the World Wide Web, it has become common for merchants to set up websites for marketing goods and for individual shoppers to use websites for reviewing and recommending goods. One example of such a website is the online site MAKEUPALLEY.COM. Via this site, a shopper can access information on a variety of goods and make purchase decisions based on reviews given by other shoppers who are familiar with the products being discussed. Another example is BLOGGER.COM, where shopper-users may post reviews of products as well as links to sales of merchants for other shoppers to purchase products.

One problem commonly encountered by online businesses is an inability to effectively market goods via their websites. Because the shopper cannot physically inspect the products via the website and typically cannot talk to a salesperson, it is desirable that the website provides access to product reviews, product ratings, and other information that can be relied on by the shopper to make an informed decision. In many cases, however, the merchant lacks the resources needed to generate or otherwise obtain such information, especially if the merchant sells a large and diverse selection of goods. For example, it would not be practical for AMAZON.COM to prepare reviews for all, or even a significant portion of, the millions of products available on the AMAZON.COM website. As such, via its website, shoppers may register to post reviews of products available for the benefit of other shoppers. This method, however, may not be desirable for many web merchants because of the low participation rate by shoppers due to the lack of incentive, as is evident for SAKSFIFTHAVENUE.COM with its review system. Therefore, some web merchants, some as large as NEIMANMARCUS.COM, do not use shopper review systems at all.

Another problem commonly faced by online merchants is an inability to effectively attract potential shoppers to their websites. One way of attracting shoppers has been to market its website through radio, television, newspaper, and Internet advertisements. However, advertising a website using conventional methods can be expensive, and can consume significant human and financial resources. In addition, it is often difficult or impossible to evaluate the effectiveness of a given advertisement.

Another problem commonly faced by online merchants is an inability to effectively incentivize shoppers to continually participate in the referral process. One way of providing incentives to shoppers to refer other shoppers to a particular online merchant is to provide a credit or a discount for the referring shoppers for future purchases for referring other shoppers to register and purchase at least once from the online merchant. For example, GILT.COM provides registered shoppers a certain amount of credit after referring other shoppers to register and make at least one purchase through their website. This commonly employed method, however, only provides incentives to the shoppers if they refer potential shoppers to a particular website. Furthermore, registered shoppers are interested mainly in referring as many other potential shoppers to the website as possible, rather than a particular product. They have little, if any, incentive to provide reviews or recommendations of products. The shoppers are limited to the websites, and therefore products, which they can recommend. The credits received are also limited to the particular website to which they referred the potential shoppers. Potential shoppers are also less likely to receive accurate reviews of products or even the websites, because it is essentially a one-time deal since the shoppers receive credit for referral to the website for the initial purchase only, and no credit for any future purchases by the referred shopper. Moreover, the shoppers also have little to no incentive to encourage other shoppers to continue purchasing products as this provides no benefit to the referring shoppers. Finally, potential shoppers generally cannot determine and differentiate the trustworthiness and reliability of a particular referring shopper from another. The present invention addresses these and other problems.

### OBJECTIVE OF THE INVENTION

Accordingly, it is an object of the invention to provide static and/or real-time shopper-to-shopper-driven access to personalized shopping experiences, specifically in the context of personalized shopping advice.

It is also an object of the invention to allow shoppers to present a query regarding needs for products and services, wherein the query can be as general as for a recommendation of products or services, or as specific as for a particular brand of product.

It is also an object of the invention to provide shoppers with experts to recommend goods and services based on the particular shoppers' needs, wherein the experts have fields of specialty in which they have expertise.

It is also an object of the invention to allow experts to provide real-time communication in response to the shoppers' requests for goods or services, wherein the shoppers and the experts may interact through web chat, video conference, or any other forms of real-time communication.

It is also an object of the invention to allow experts to provide non-real-time communication in response to the shopper's request for goods or services, wherein the shoppers and the experts may interface through the use of emails, forum posts, or any other forms of non-real-time communication.

It is also an object of the invention to allow experts to be rated by the shoppers based on various criteria, including the expertise of the experts in their particular field or fields, the quality and/or price of the goods and services provided, or any other quality as deemed important by the shoppers.

It is also an object of the invention to provide monetary or other incentive to experts for providing personalized shopping experiences of goods and services of various merchants to the shoppers, wherein the monetary or other incentive is available from merchants participating in the referral system herein disclosed.

It is also an object of the invention to provide a monetary or other incentive to experts for sharing their expertise with potential shoppers, wherein shoppers can utilize the information provided by the experts and select the products or services that best match the needs of the shoppers.

It is also an object of the invention to automatically generate a new link to a recommended product or store from an original link provided by the experts having at least the merchant ID and/or the product ID wherein the newly generated link further contains information such as the shopper ID, expert ID and/or affiliate ID. The information contained in the referral link is used to determine to whom the commission belongs.

### SUMMARY OF THE INVENTION

In one aspect of the invention, disclosed is a method to facilitate an interaction platform for exchanges of user-to-user advice comprising: providing a network; providing a host computer system wherein the host computer is connected to the network wherein the host computer provides an interaction platform for one or more advice providers to provide advice regarding one or more products to one or more advice receivers; the advice is provided to the advice receiver via the interaction platform. The host computer further provides a database storing one or more attributes of the advice provider and one or more attributes of the advice receiver.

In one embodiment, the attributes of the advice provider are selected from a group consisting of the age of the advice provider, response time of the advice provider, satisfaction rating of the advice provider, language spoken by the advice provider, experience of the advice provider, subject acumen of the advice provider, geographical location of the advice provider, gender of the advice provider. In another embodiment, the attributes of the advice receiver are comprised of language spoken by the advice receiver, inquiry subject of the advice receiver, geographical location of the advice receiver, gender of the advice receiver, available wait time of the advice receiver, and speed of response time required by the advice receiver.

In one embodiment the advice receiver selects the advice provider to engage based on the attributes of the advice provider. In another embodiment, the platform selects the advice provider to engage the advice receiver based on the attributes of the advice provider and the attributes of the advice receiver. In one embodiment, the platform selects the advice provider to engage the advice receiver based on matching the attributes of the advice provider to the attributes of the advice receiver. In one embodiment, the platform selects the advice provider to engage the advice receiver based on matching the attributes of the advice provider to the attributes of the advice receiver using a predetermined algorithm. In one embodiment, the algorithm can be adjusted. In one embodiment, the algorithm assigns different priorities to the attributes of the advice provider.

In one embodiment, the algorithm assigns different priorities to the attributes of the advice receiver. In one embodiment, the advice receiver can also be an advice provider. In one embodiment, the advice receiver can rate the advice provider based on advice receiver's experience with the advice provider. In one embodiment, the advice provider is connected to the platform through an internet access device. In one embodiment, the internet access device is selected from a group which consists of computer, cellular phone, and computer tablets. In one embodiment, the advice provider is engaging the advice receiver in real-time. In one embodiment, the advice provider is engaging the advice receiver in real-time via web camera.

In one embodiment, the advice provider is engaging the advice receiver in real-time via website chat functions. In one embodiment, the advice is shopping advice. In one embodiment, the product is a form of service. In one embodiment, the advice is comprised of a website link having a merchant identification to identify a merchant and possibly a product identification to identify a product. In one embodiment, the advice receiver makes a transaction as a result of the advice, wherein the advice provider receives an advice provider commission in cash or points in connection to the transaction.

In one embodiment, the interaction platform receives a merchant commission from the merchant wherein the merchant is a registered merchant of the interaction platform wherein the platform provides the commission to the advice provider. In one embodiment, the merchant is a registered merchant of a merchant affiliate network. In one embodiment, the interaction platform is connected to the merchant affiliate network wherein the merchant affiliate network receives an affiliate merchant commission from the merchant and the interaction platform receives an affiliate commission from the merchant affiliate network wherein the advice provider receives the advice provider commission from the interaction platform.

In one embodiment, the interaction platform automatically changes the website link to further include an identification of the advice provider and/or an identification of the advice receiver. In one embodiment, the interaction platform automatically changes the website link to further include an identification of the advice provider, an identification of the advice receiver and/or an identification of the interaction platform.

### BRIEF DESCRIPTION OF THE DRAWINGS

These and other features and advantages of the invention will not be described with reference to the drawings of certain preferred embodiments, which are intended to illustrate and not to limit the invention, and in which:

FIG. 1 is a high-level architectural drawing illustrating the primary components of a system that operates in accordance with the present invention.

FIG. 2 is an architectural drawing and flow diagram illustrating the enrollment function of the system.

FIG. 3 is an architectural drawing illustrating the computer software within the computer program for the system.

FIG. 4a is the screen display illustrating the enrollment function.

FIG. 4b is the screen display further illustrating the enrollment function.

FIG. 5 is the screen display illustrating the questions presented by shoppers.

FIG. 6 is the screen display illustrating the input field for the original URL of the product or services available from the merchant.

FIG. 7 is the screen display of an input field for the original product URL automatically generating a referral URL.

FIG. 8 illustrates the original URL format and the automatically generated URL with the embed referral information in accordance with the invention.

FIG. 9 is the screen display of a non-real time interface between a shopper and an expert in providing recommendations based on the need of the shopper.

FIG. 10 is the screen display of a live video/voice chat session for shoppers and experts to interact in real time.

FIG. 11 is the schematic diagram illustrating in one embodiment the flow commissions between merchants, experts, and shopping advice platform.

FIG. 12 is the schematic diagram illustrating in one embodiment the flow commissions between merchants, merchant affiliate networks, experts, and shopping advice platform.

FIG. 13 is the screen illustration of a real-world interaction for the advice receiver to select the desired criteria in the advice provider.

FIG. 14 the screen illustration of an internet enabled interaction for the advice receiver to select the desired criteria in the advice provider.

FIG. 15 high level drawing symbolizing the criteria selection in reaching the best-matched advice provider.

### DETAIL DESCRIPTION OF THE INVENTION

The present invention provides a method for a system (shopping advice platform) to provide experts (“experts”) to receive commission efficiently for recommending goods on the shopping advice platform sold by participant merchants (“merchants”) or a non-participant merchant who is a member of a merchant affiliate program. All the merchants will have a unique identification (“merchant ID”), and all the shoppers will have a unique identification (“shopper ID”). The system and method are implemented in part by computer that manages the shopping advice platform.

Through this platform, any shopper can ask specific questions on the shopping advice platform to receive recommendations for products or services tailored specifically to the shopper. Anyone can enroll in the shopping advice platform (via a registration process) as an expert, upon which the expert will be assigned a unique code (“expert ID”). Experts can then provide reviews and recommend products and services in general or to specific questions posted on the shopping advice platform. The shoppers who post the questions on the shopping advice platform, along with anyone else who is persuaded by the review or recommendation of the experts, can purchase the products or services through a referral link, which is automatically generated from the expert's original merchant-specific or merchant-product-specific hyperlink, taking the shoppers straight to the merchants. Specifically, the present invention provides a method to automatically generate a new link (referral link) from the expert's proposed original links (merchant- and/or product-specific hyperlink) to further include an expert ID, a shopper ID and/or an affiliate ID.

The method can be employed in an internet-based referral system (shopping advice platform) that enables users (experts) to interact with other users (shoppers) by making recommendations or reviewing products and goods of any participating merchant to fulfill the needs of the users. The experts initially enroll or register on a platform offering shopping advice (shopping advice platform) as experts, and receive an associated expert code (“expert ID”) that identifies the referring expert. The expert may, for example, provide reviews, recommendations, and/or editorials of specific products. More specifically, the expert may answer specific questions of shoppers, either through real-time or non-real-time response, by making recommendations of goods or services of any merchant to the shoppers based on their needs. The expert's recommendation will typically include a link having a merchant ID and/or product-specific ID, then, either in real-time or on a static page, the platform automatically generates a new link (“referral link”) to further include the ID of the expert, the affiliate code, and/or the shopper's identification (“Shopper ID”). The shopper can make a query in the form of a message on the platform, and the experts can answer the query via posting messages with website links to recommended products or services tailored towards the shopper, upon which an email is sent to the shopper notifying that the query has been answered. Alternatively, the shopper can also make real-time query in the form of a chat or video chat, wherein the experts can answer the query and provide a website link to the recommended products or services tailored towards the shopper via chat, video chat, or a combination thereof. When a shopper follows such link and then makes a purchase (as tracked by the merchant's website), the method provides the ability for the participating merchant or non-participating merchant who are members of an existing merchant affiliate network to pay commission to the expert who provided the referrals.

Specifically, in the case where the merchant is a participating merchant on the shopping advice platform, the merchant pays commission directly to the experts.

In the case where the merchant is a non-participating merchant who belongs to a merchant affiliate network, the merchant pays the commission to the affiliate network which the affiliate network in turns pays the shopping advice platform and the shopping advice platform in turns pays the experts who made the referrals. Specifically, the merchant affiliate network uses this information to identify the shopping advice platform that referred the shopper to the merchant site. If the shoppers subsequently purchase the selected product from the merchant site (e.g., by filing out an order form page and submitting the order), the merchant affiliate network automatically credits the corresponding shopping advice platform via identification through an affiliate code. Thereafter, the shopping advice platform, using the expert ID information corresponding to the sales, credits the referring experts by, for example, applying a commission or other incentive to the accounts of the corresponding experts.

In one implementation, the referral commission is automatically generated based on a fixed percentage of the merchant's selling price, and is paid to the expert electronically on a periodic basis (such as every calendar quarter). In accordance with another aspect of the invention, the shopping advice platform implements an automated expert enrollment process for allowing individuals (“applicants”) to register as experts in order to generate the referral links. The enrollment process is implemented in part by web pages that are transmitted to the computer of the applicants, and by enrollment software that runs on the shopping advice platform's site. During the enrollment process, the applicants are presented with an online business agreement (in the form of a web page) that sets forth the terms and conditions of doing business with, or participating in the program of, the shopping advice platform. In addition, the applicant is presented with an online form that requests from the applicants various information, such as name, payment address, and e-mail address.

In one implementation, the enrollment software includes text scanning code that automatically scans the completed form for pre-specified words and phrases (vulgarities, etc.) that may give rise to a rejection of the application, and flag the application for further (human) review when such a word or phrase is found.

In one implementation, the various components are provided on a shopping advice platform for users to be enrolled as experts. Via said shopping advice platform, users can register as experts and can then provide recommendations and/or reviews of products from any merchant website. For example, an expert with expertise in computers can make recommendations of a particular laptop that the expert believes is well-suited for a particular shopper (a businessman) who is looking for a laptop for a particular purpose (a business trip). The expert, in turn, is paid with commission or other considerations based on the referrals that result in actual purchases from a merchant, if a merchant is either a participating merchant with the shopping advice platform or a merchant within the affiliate network that has a relationship with the shopping advice platform.

An important benefit of the invention is that it allows the task of marketing the merchant's products to be efficiently distributed among the experts who can establish reputations within their respective fields of expertise through the shopper ratings system. Another benefit is that it provides an efficient mechanism for exposing the merchant's website to the public, by encouraging others (experts) to set up outgoing links to the merchant's site. In addition, shoppers can receive personalized shopping experiences through the expertise of the experts who will tailor the recommendations of products to the needs of the shoppers.

Because the expert enrollment and the referral tracking/credit functions are automated in whole or in part, the architecture allows for these benefits to be realized with minimal supervision by the merchant and with minimum input from the experts. In addition, because the compensation provided to the expert is performance-based (e.g. based on the revenue generated from the referrals that result in actual sales), the merchant need not be concerned with the existence of large numbers of marginally-productive experts who provide relatively small number of referrals.

Although the embodiment described herein uses web technology to disseminate the catalog documents, any of a variety of document types and electronic dissemination technologies can be used. For example, the affiliate catalog documents may be in the form of hypertextual email messages that are disseminated by a PUSH server. Further, although hypertextual catalog documents are preferably used, it is possible for an expert to use non-hypertextual catalogs that simply instruct the shopper to manually enter the appropriate URL (including the referral information) into a browser program.

### DETAIL DESCRIPTION OF THE DRAWINGS

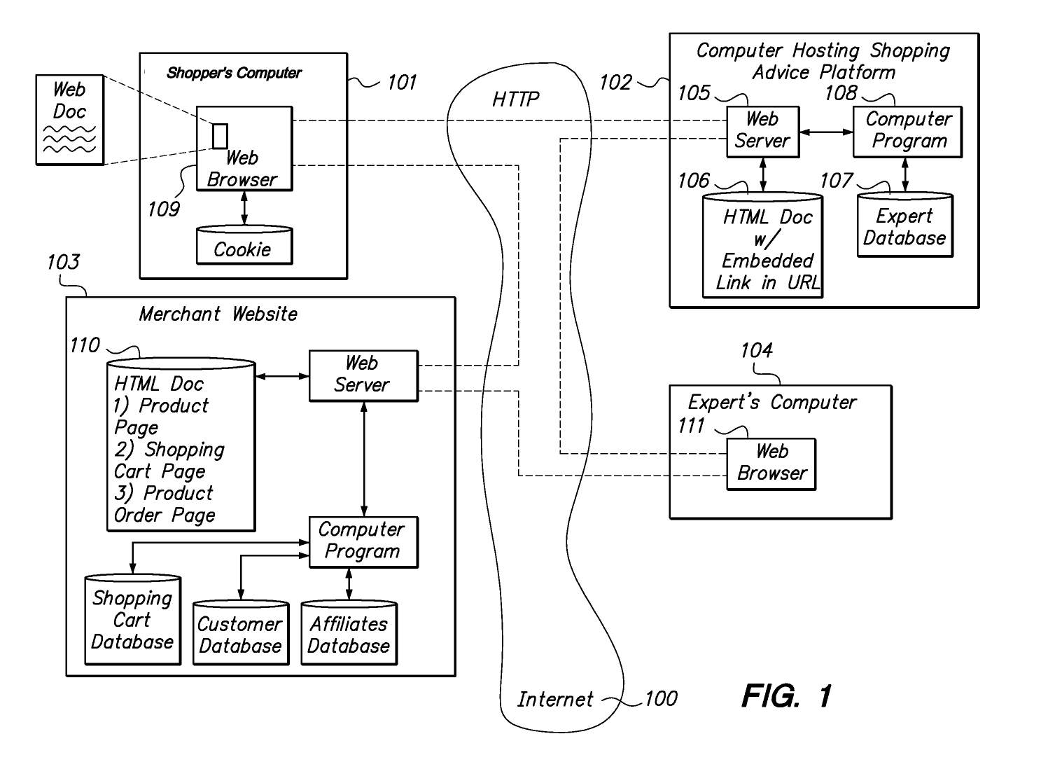

FIG. 1 illustrates the general architecture of the system that operates in accordance with the present invention. The system includes a shopper computer 101, a shopping advice platform 102, a merchant website 103, and an expert computer 104, all of which are linked together by the Internet 100. The shopper's computer 101 and the expert computer 104 may be any type of computing device that allows a user to interact with websites via a website browser 109, 111. For example, the expert computer 104 may be a personal computer (PC) that runs the Windows operating system, and the shopper computer 101 may be a personal computer (PC) that runs the Linux operating system.

The merchant website 103 is a site that provides the functions for allowing shoppers to purchase products. Typically, this site will be operated by a business entity (referred to herein as “merchant”) that handles the various order processing, shipping, collections, and shopper service tasks associated with the sale of goods.

The shopping advice platform 102 includes enrollment software that implements an online registration process for allowing other entities (individuals, companies, etc.) to register as users (referred to herein as “experts”). An entity enrolling as an expert provides the shopping advice platform 102 with a completed, online registration application that is processed by enrollment software (“SW”) at the site 102. The enrollment software creates an entry in the expert database 107 according to the information provided by the enrolling expert.

In operation, the shoppers can access the shopping advice platform 102 using a standard web browser 109, such as Mozilla's Firefox or Microsoft's Internet Explorer, which uses the HTTP protocol to communicate with a web server 105 of the shopping advice platform 102. The web server 105 accesses a local store of catalog documents 106 (in the form of HTML or “web” documents) which can be requested, retrieved, and viewed by the shoppers via the web browser 109. The shopper is able to request information regarding certain products or services through the shopping advice platform 102, wherein experts in the field may provide tailored responses to the shoppers' query.

Similarly, the experts access the shopping advice platform 102 using a standard web browser 111 to communicate with a web server 105 of the shopping advice platform 102. Via the web browser 111, the experts access the catalog documents 106 stored on the web server 105. These catalog documents 106, which can be requested, retrieved, and viewed by the experts, include information generated by the expert about the various products featured on the merchant's website 103. The experts can access the merchant website 103 to locate the desired products catalog page 110, and input the URL to the shopping advice platform 102 for access by shoppers. Preferably, this information includes editorial descriptions, reviews, and/or recommendations of the products that assist shoppers in making informed purchasing decisions.

The catalog documents 106 provided by the affiliate site 102 include special hyperlinks (to web pages of the merchant website 103) for allowing shoppers to select products for prospective purchase. Typically, one such hyperlink is provided for each product displayed on the shopping advice platform 102. When a shopper selects (e.g. clicks on) the hyperlink associated with a particular product, the shopper is automatically connected to the merchant website 103, and presented with various options (included within web pages 110 served from the merchant website 103) for allowing the shopper to purchase the selected product from the merchant. The hyperlink thus serves as a referral mechanism for referring the shopper to the merchant website 103.

As described in detail below, the special hyperlinks (referred to herein as “referral links”) of the affiliate's catalog documents are provided in association with additional information (embedded in a pre-defined format within the associated URL) that is transmitted to the merchant website 103 in response to selecting a link. In one implementation, this information includes a unique expert ID (assigned upon enrollment), unique merchant ID, and/or a unique buyer ID. A computer program 108 of the shopping advice platform 102 uses this information to identify the expert who was the source of the referral, and to credit the sale (referral) to the expert if the shopper subsequently purchases the products.

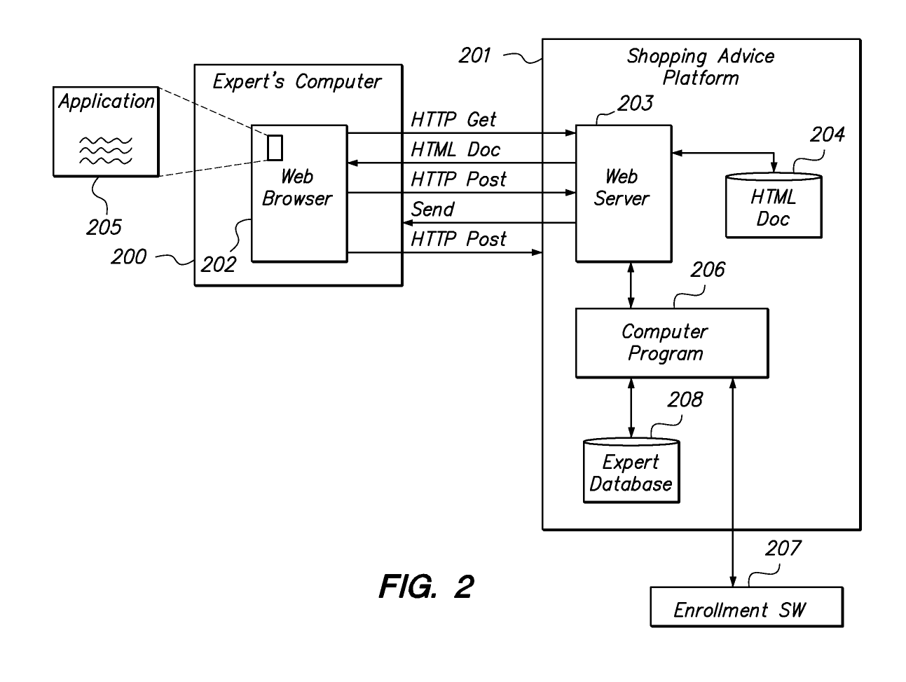

FIG. 2 illustrates the general flow of information between components when an expert applicant uses a computer 200 to enroll as an expert. The computer 200 includes a conventional web browser 202 which communicates with the merchant web server 203 using HTTP protocol. The web server 203 accesses a local store of HTML documents (web pages) 204 which can be requested, retrieved and viewed by the applicant via web browser 202. These documents may, for example, include information about registering online to become an expert. Access to the shopping advice platform 201 and the enrollment function is available to any client computer 200, and the enrolling expert is not required to have an established website at the time of enrollment.

As further illustrated in FIG. 2, the enrolling expert begins the enrollment function by selecting the proper HTTP hyperlink from the affiliate web pages 204 containing online HTML registration application documents 205, which is sent to the enrolling expert's web browser 202. The enrolling expert can then fill out the detailed online application form 205 for transmission as HTTP post message with enrollment data to the affiliate web server 203 for storage in database 208.

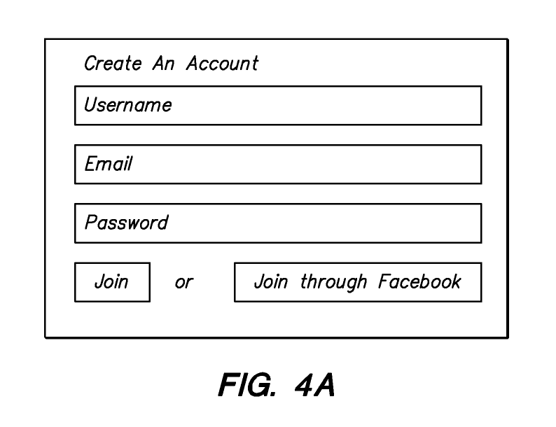

Referring to FIGS. 4a and 4b, a preferred embodiment of the online application form 205 is shown. The application requests information about the enrolling expert, including the expert's username, email and password. Many alternative formats to the online application form are possible, and FIGS. 4a and 4b are only representative of the types of information that may be requested.

With further reference to FIG. 2, once the electronic application form 205 is completed by the enrolling expert, it is sent from the expert's computer 200 to the affiliate web server 203 for further processing. As will be appreciated by those skilled in the art, other forms of enrollment processing may be used, including but not limited to regular mail and electronic mail.

In response to submission of the enrollment form, the affiliate web server 203 initiates a computer program 206 comprising enrollment software 207 that process the information contained on the electronic application form 205. As part of this online registration, once the application has been processed (either automatically or with human intervention), the enrollment software generates a unique expert ID to be assigned and sent to the expert. In addition, the enrollment software creates a database entry corresponding to the enrolling experts and stores the information in an expert database 208. Upon such enrollment, the experts can send, via their web browser 202, HTTP post message with data to the affiliate site 201 to recommend and/or review products or services as necessary or desired.

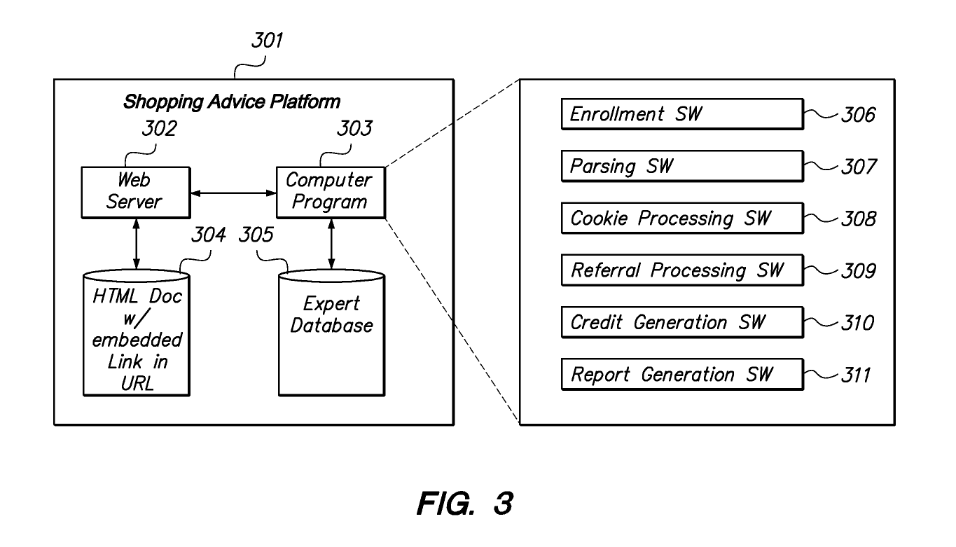

Referring to FIG. 3, the shopping advice platform 301 contains a computer program with the necessary software (“SW”) for the functioning of the present invention. Via the catalog document 304, the expert's registration information is processed through the web server 302. The web server processes the information through a computer program 303, which contains various software, including enrollment software 306, parsing software 307, cookie processing software 308, referral processing software 309, credit generation software 310, report generating software 311, etc. The expert's registration information is then stored as an entry into the expert database 305.

With Further reference to FIG. 2, the computer program 206 automatically formats and transmits an electronic mail message to the email address of the approved expert. Furthermore, the expert is associated with a unique expert ID, which is used to attach to the URLs provided by the expert on the shopping advice platform 201.

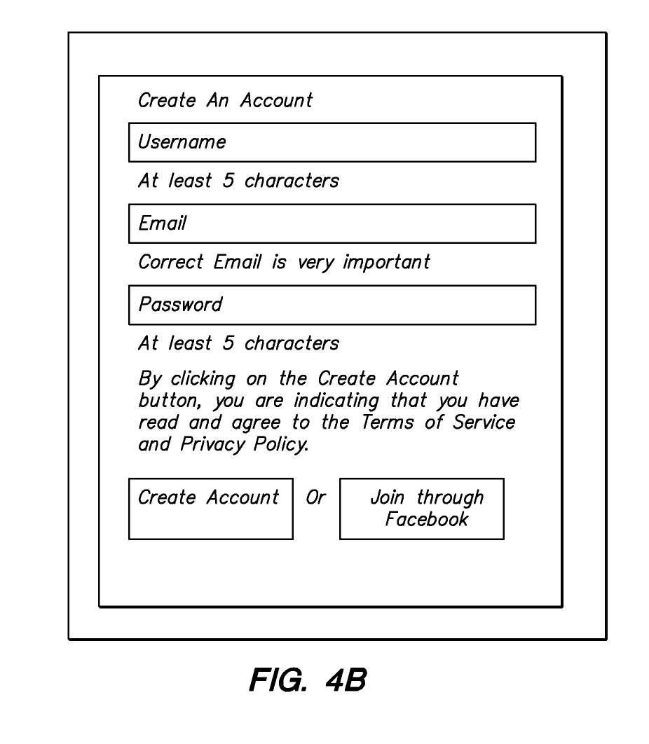

Referring to FIG. 5, shoppers may access the shopping advice platform to post questions regarding specific products or services sought. A shopper 502 may present a general query to specific needs 500, such as searching for a digital single lens reflex (DSLR) camera, with specific limitations or qualifications 501, such as less than $1,000 in price. Experts may be able to browse through such queries 505, 506 and, based on when the query was presented 503 and whether and how often the query has been answered 504, the expert can decide whether to assist this particular shopper 502 in the proposed query 500 to satisfy the needs of the shopper 502.

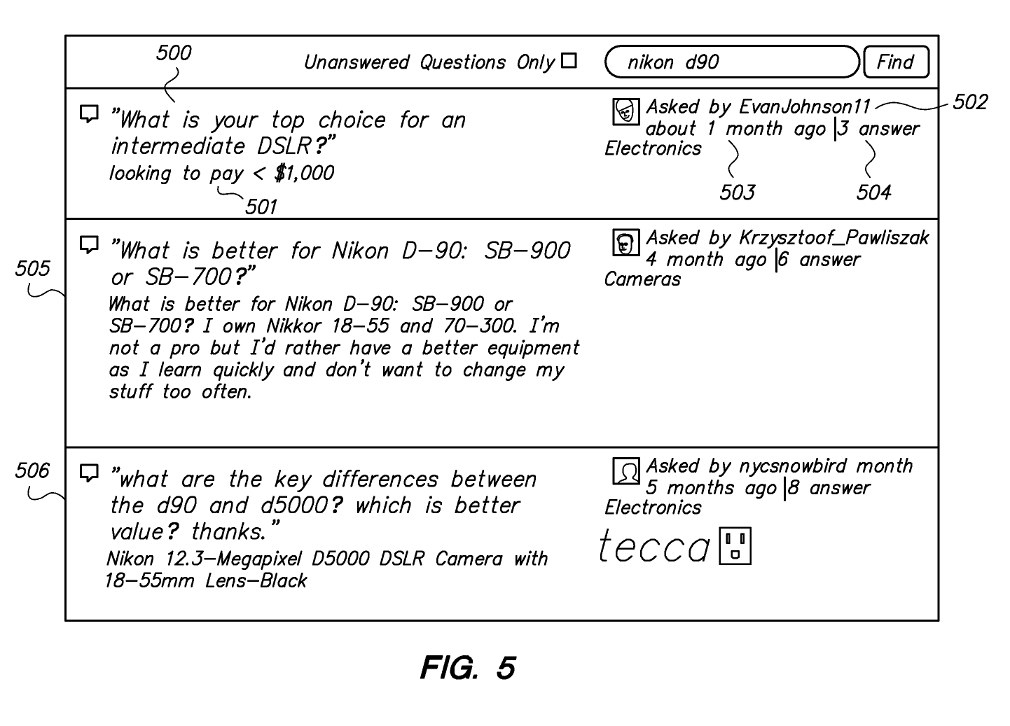

Referring to FIG. 6, upon finding a suitable query in their field of expertise, experts may response to the query with descriptions, reviews, and/or recommendations, as well as by providing a link to the ideal product from a merchant. The expert may input the external link of a merchant into the input field 600, and click 601 to automatically generate a referral link.

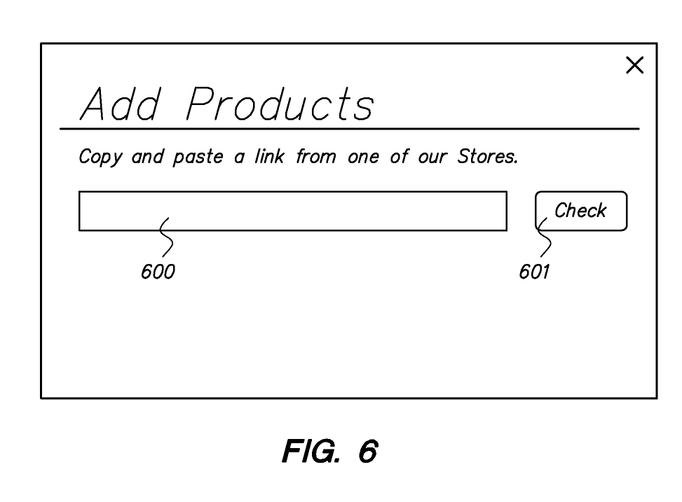

Referring to FIG. 7, from the original link 700, the expert may click 701 to generate a referral link, wherein, also generated is a brief description of the recommended product 703 and a thumbnail view of the picture of the product 702. Upon the satisfaction of the correct description and product 703 to recommend to the shopper, expert can click 704 to add the automatically generated referral link on the affiliate page as an answer to the query posed by the shoppers.

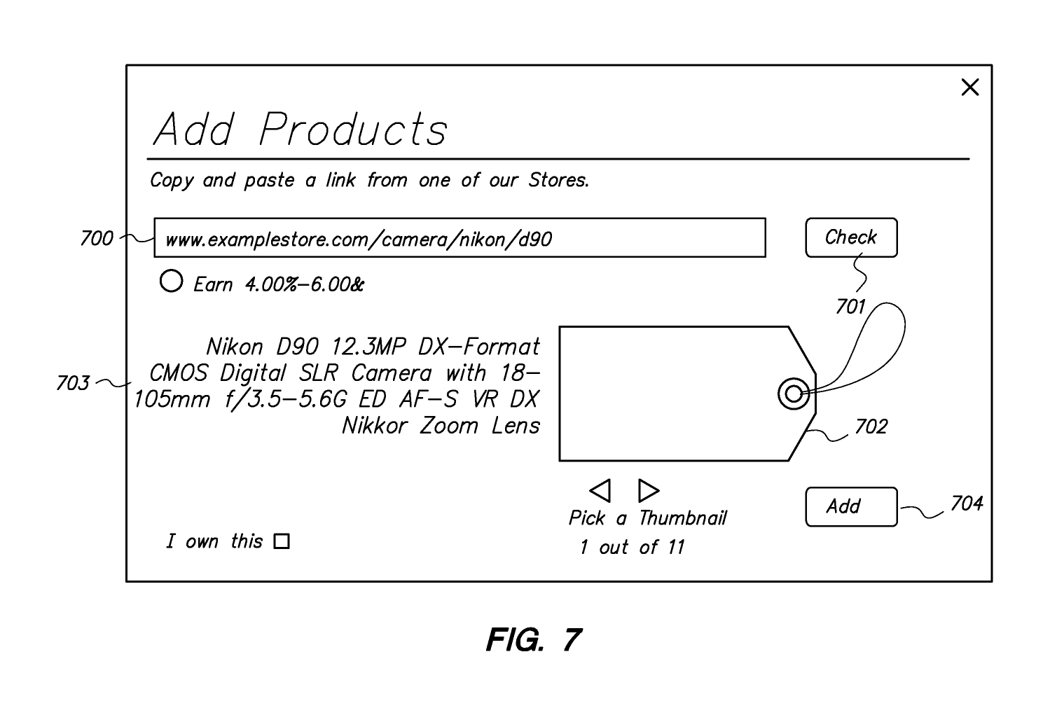

Referring to FIG. 8, the original link to the product 800 may be understood to contain the merchant web URL 801, product category 802, product brand 803, and the specific product identification 804. The automatically generated referral link 805 would contain the original link 806 plus referral information such as the expert ID 807, the seller identification 808, and the buyer identification 809. The expert ID 807 allows the corresponding expert to receive the commission for making the referral. The seller identification 808 allows the appropriate commission to be calculated, as the commissions are based on a percentage of the referral sale. The buyer identification 809 allows for the tracking the buyer to confirm the referral sale was indeed successful.

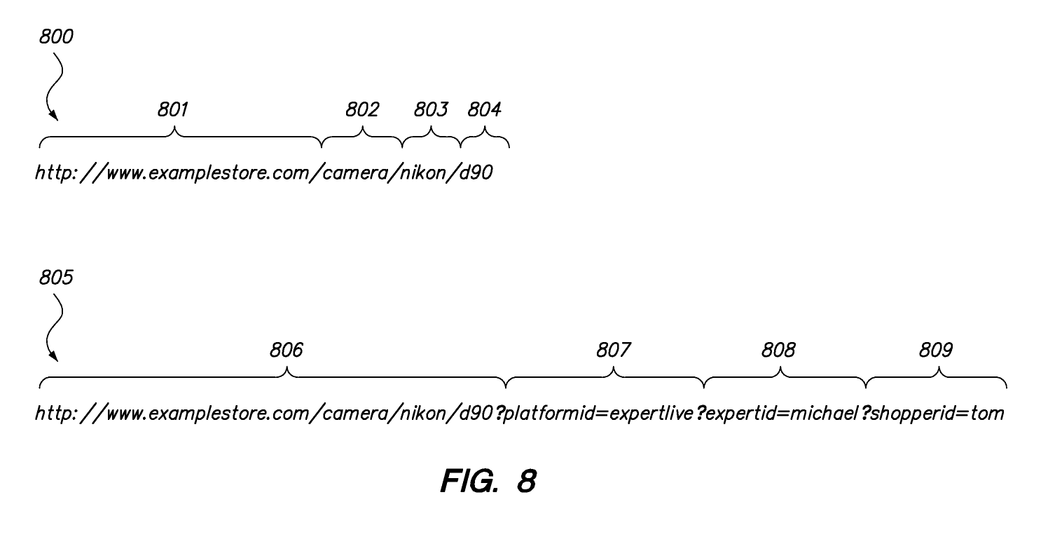

FIG. 9 illustrates a screen display of a typical non-real time entry of shopper query followed by an entry of expert solution. The shopper query is provided at the top 900, with expert solutions regarding the number of solutions provided 901. Each answer can be voted by readers indicating whether the answer is helpful 903. The best answer to the shopper query 902 is displayed at the top, for the benefit of the shopper.

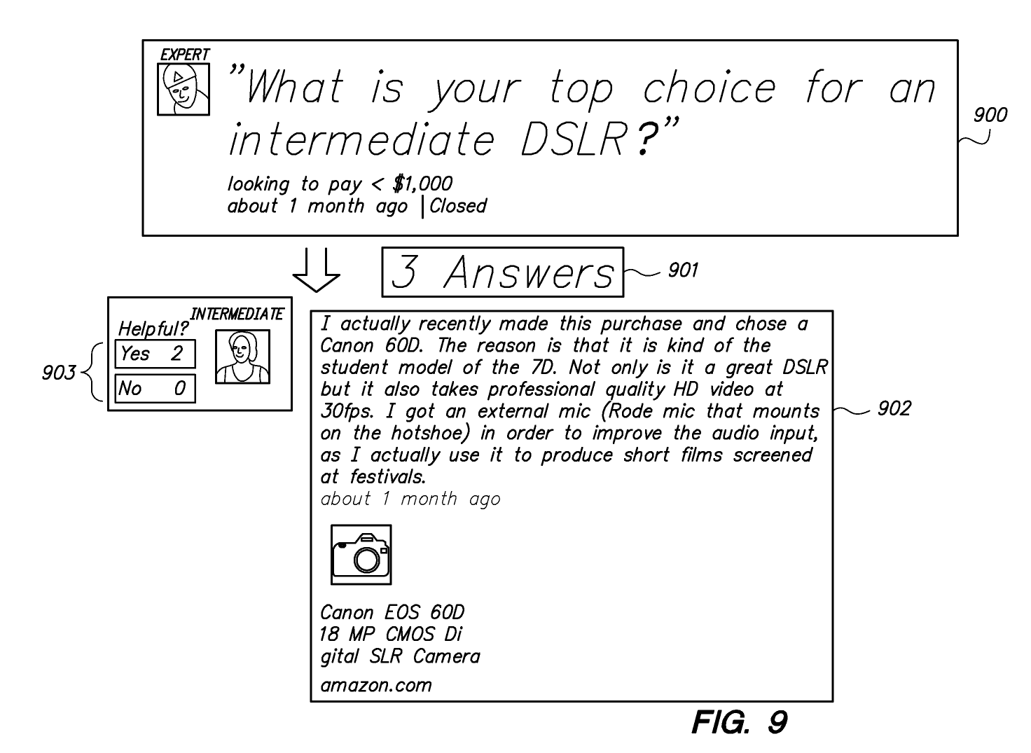

FIG. 10 illustrates a screen display of a real time interface between shopper and expert. Both the shopper and the expert may control whether to use video 1000, microphone 1001, or to simply communicate through live chat 1002.

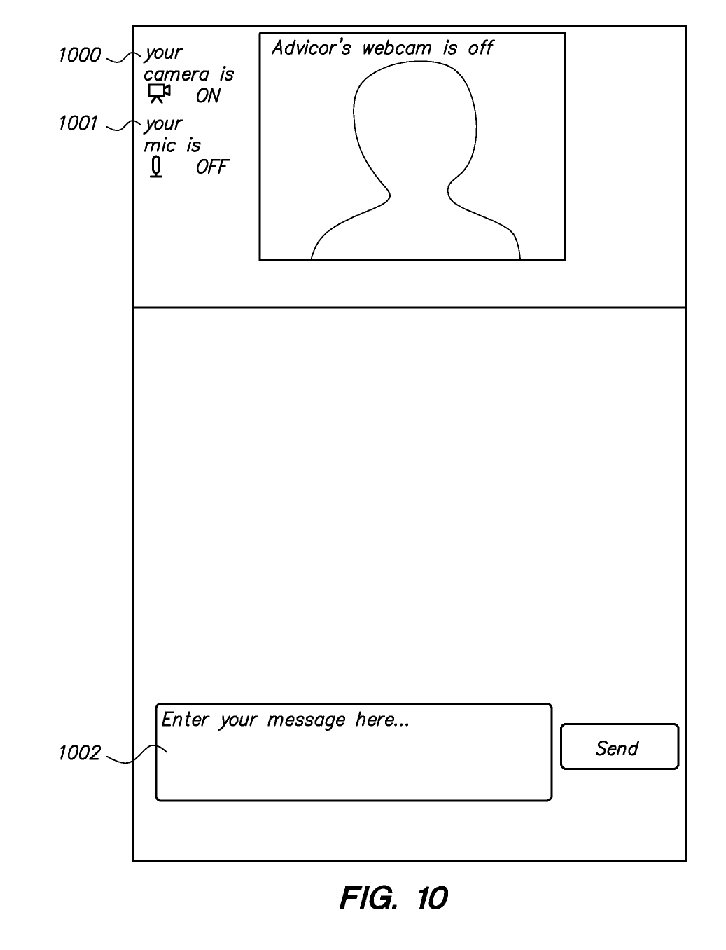

FIG. 11 illustrates one embodiment of present invention as to how the commissions are paid directly from the merchant 1101. Specifically, in this embodiment, merchant 1101 is linked directly with the shopping advice platform 1108. Here, the expert 1105 provides shopping advice 1104 and posts the advice on the shopping advice platform 1108 where the shopper 1103 takes advantage of it by clicking on the link to make a purchase 1102 from the merchant 1101. The merchant 1101 then pays a merchant commission 1107 to the shopping advice platform 1108 and it then pays an advice provider commission 1106 to the expert 1105.

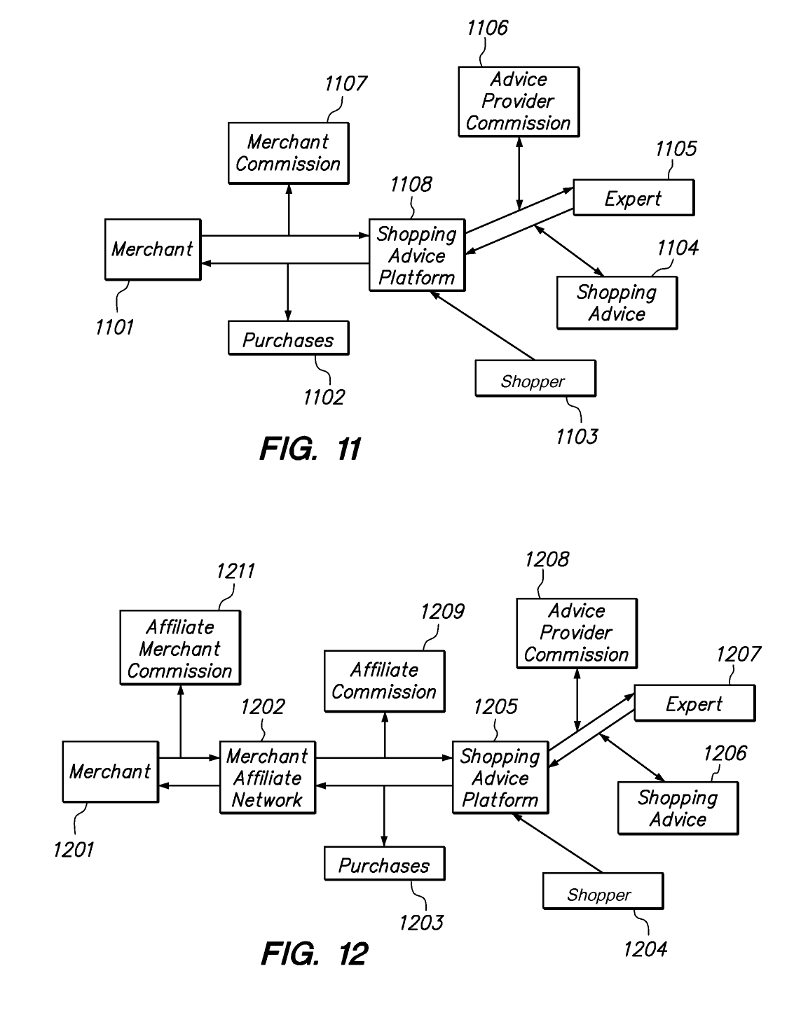

FIG. 12 illustrates another embodiment of present invention as to how the commissions are paid. Specifically, here the merchant 1201 isn't directly linked with the shopping advice platform 1205. Here, the merchant 1201 is linked with a merchant affiliate network 1202. An example of merchant affiliate network includes commission junction and/or link exchange. On the other hand, the shopping advice platform 1205 is linked directly with the merchant affiliate network 1205. So here, an expert 1207 provides an advice 1206 and posts a link on the shipping advice platform 1205, and the shopper 1204 follows the link to make purchases 1203 from the merchant 1201. The merchant then issues affiliate merchant commission 1211 to the merchant affiliate network 1202 and then the merchant affiliate network 1202 issues an affiliate commission 1209 to the shopping advice platform 1205. It is then, here, that the shopping advice platform 1205 then issues the advice provider commission 1208 to the expert 1207.

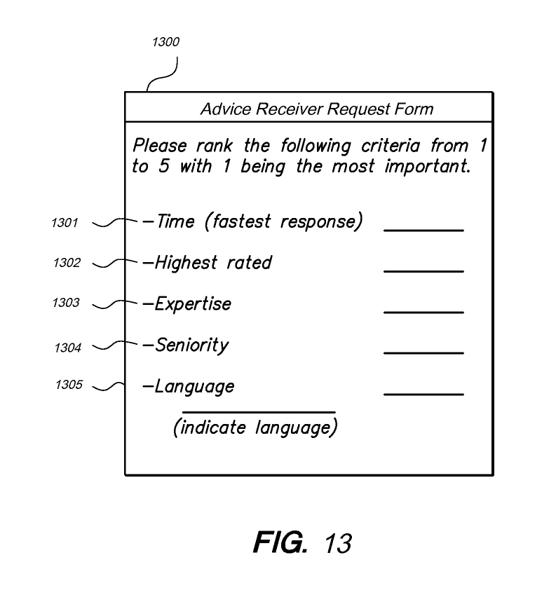

FIG. 13 a screen illustration of an embodiment of a type of physical world choosing, wherein the advice receiver seeking an advice provider gives the criteria desired of an advice provider by ranking the specific criteria with a form 1300, wherein the criteria may include, but not limited to, the response time of the advice provider 1301, the rating of advice provider 1302, the expertise of the advice provider 1303, the experience of the advice provider 1304, and the language in which the advice provider is proficient 1305. Upon the selection of the criteria by the advice receiver, the advice receiver system may then process the data provided by the form 1300 into the system to match the advice receiver with the best-suited advice provider available.

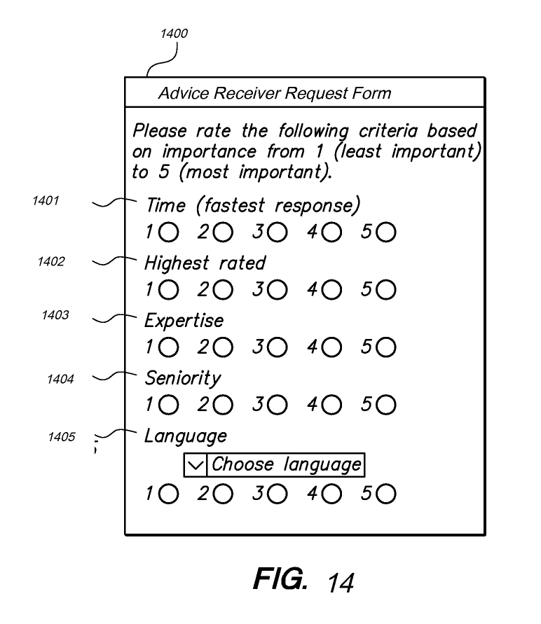

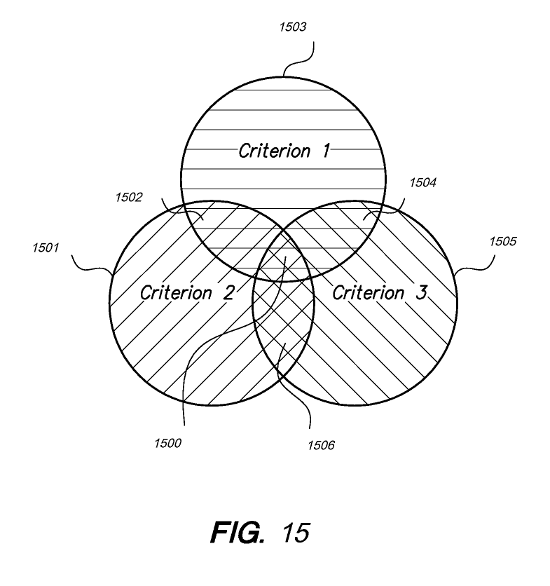

FIG. 14 is a screen illustration of an embodiment of a type of web enabled interactive form 1400, wherein the advice receiver seeking an advice provider gives the criteria desired of an advice provider by ranking the specific criteria with a form 1400, wherein the criteria may include, but is not limited to, the response time of the advice provider 1401, the rating of advice provider 1402, the expertise of the advice provider 1403, the experience of the advice provider 1404, and the language in which the advice provider is proficient 1405. Upon the selection of the criteria by the advice receiver, the advice receiver system may then process the data provided by the form 1400 into the system to match the advice receiver with the best-suited advice provider available.

FIG. 1500 is a Venn diagram illustrating the visual representation of the criteria used by the support system to analyze and select the pool of advice providers 1500. Each criterion is a specific trait or characteristic desired by the advice receiver, such as the response time of the advice provider, the rating of advice provider, the expertise of the advice provider, the experience of the advice provider, or the language in which the advice provider is proficient. As such, those advice providers who satisfy the first criterion 1503 is overlapped with those satisfying criterion 2 1501, upon which they are overlapped with those satisfying criterion 3 1505, wherein those matching all criteria 1500 are selected. If none of the advice providers matching all criteria 1500 are available, those next best match the given criteria 1502, 1504, 1506, are selected to be match with the advice receiver.

What is claimed is:

1. A method to facilitate an interaction platform for exchanges of user to user advice comprising:
a. providing a network;
b. providing a host computer system wherein said host computer is connected to said network wherein said host computer provides an interaction platform for one or more advice provider to provide advice regarding one or more products to one or more advice receivers;
c. said advice is provided to said advice receiver via said interaction platform.
d. said host computer further provides a database storing one or more attributes of said advice provider and one or more attributes of said advice receiver.

2. The method of claim 1 wherein said attributes of said advice provider is selected from a group consisting of age of said advice provider, response time of said of said advice provider, satisfaction rating of said advice provider, language spoken of said advice provider, experience of said advice provider, subject acumen of said advice provider, geographical location of said advice provider, and gender of said advice provider.

3. The method of claim 1 wherein said attributes of said advice receiver are comprised of language spoken of said advice receiver, inquiry subject of said advice receiver, geographical location of said advice receiver, gender of said advice receiver, available wait time of said advice receiver, and speed of response time required by said advice receiver.

4. The method of claim 1 wherein said advice receiver selects said advice provider to engage based on said attributes of said advice provider.

5. The method of claim 1 wherein said platform selects said advice provider to engage said advice receiver based on said attributes of said advice provider and said attributes of said advice receiver.

6. The method of claim 5 wherein said platform selects said advice provider to engage said advice receiver based on matching said attributes of said advice provider to said attributes of said advice receiver.

7. The method of claim 6 wherein said platform selects said advice provider to engage said advice receiver based on matching said attributes of said advice provider to said attributes of said advice receiver using a predetermined algorithm.

8. The method of claim 7 wherein said algorithm can be adjusted.

9. The method of claim 7 wherein said algorithm assigns different priorities to said attributes of said advice provider.

10. The method of claim 7 wherein said algorithm assigns different priorities to said attributes of said advice receiver.

11. The method of claim 1 wherein said advice receiver can also be an advice provider.

12. The method of claim 1 wherein said advice receiver can rate said advice provider based on advice receiver experience with said advice provider.

13. The method of claim 1 wherein said advice provider is connected to said platform through an internet access device.

14. The method of claim 13 wherein said internet access device is selected from a group consisted of computer, cellular phone, and computer tablets.

15. The method of claim 1 wherein said advice provider is engaging said advice receiver in real-time.

16. The method of claim 15 wherein said advice provider is engaging said advice receiver in real-time via web camera.

17. The method of claim 15 wherein said advice provider is engaging said advice receiver in real-time via website chat functions.

18. The method of claim 1 wherein said platform sends notification to said advice receiver once advice provider provides said advice on said platform.

19. The method of claim 1 wherein said advice is shopping advice.

20. The method of claim 1 wherein said product is a form of service.

21. The method of claim 1 wherein said advice is comprised of a website link having a merchant identification to identify a merchant and a product identification to identify a product;

22. The method of claim 21 wherein said advice receiver makes a transaction as a result of said advice, wherein said advice provider receives an advice provider commission in connection to said transaction.

23. The method of claim 22 wherein said interaction platform receives a merchant commission from said merchant wherein said merchant is a registered merchant of said interaction platform wherein said platform provides said advice provider commission to said advice provider.

24. The method of claim 22 wherein said merchant is a registered merchant of a merchant affiliate network.

25. The method of claim 24 wherein said interaction platform is a connected to said merchant affiliate network wherein said merchant affiliate network receives an affiliate merchant commission from said merchant and said interaction platform receives a affiliate commission from said merchant affiliate network wherein said advice provider receives said advice provider commission from said interaction platform.

26. The method of claim 21 wherein said interaction platform automatically changes said website link to further include an identification of said advice provider and an identification of said advice receiver.

27. The method of claim 21 wherein said interaction platform automatically changes said website link to further include an identification of said advice provider and an identification of said advice receiver and an identification of said interaction platform.
